(19) United States
(12) Patent Application Publication
(10) Pub. No.: US 2013/0063682 A1
(43) Pub. Date: Mar. 14, 2013

(54) Optical Film and Backlight Module and LCD Device Having the Optical Film

(71) Applicants: Yan Zuo Chen, Ping-Zhen City (TW); Wen Feng Cheng, Ping-Zhen City (TW); Hao-Xiang Lin, Ping-Zhen City (TW); Jui Hsiang Chang, Ping-Zhen City (TW)

(72) Inventors: Yan Zuo Chen, Ping-Zhen City (TW); Wen Feng Cheng, Ping-Zhen City (TW); Hao-Xiang Lin, Ping-Zhen City (TW); Jui Hsiang Chang, Ping-Zhen City (TW)

(73) Assignee: ENTIRE TECHNOLOGY CO., LTD., Ping-Zhen City (TW)

(21) Appl. No.: 13/312,735

(22) Filed: Dec. 6, 2011

(30) Foreign Application Priority Data
Sep. 14, 2011 (TW) 100132971

(51) Int. Cl. G02F 1/13357; F21V 8/00

(52) U.S. Cl. 349/65; 362/608

(57) ABSTRACT

An optical film is to attach on a light-incident surface of a light guide plate which cooperates with a plurality of side-light sources in order to form a backlight module. A plurality of specially designed micro-structures is formed on the optical film to better deflect the light generated by the side-light sources before the light enters the light guide plate. Such that, by having the optical film, the dark areas of the light guide plate can be reduced, the effective visual area of the LCD device can be enlarged, and the number of side-light sources as well as the cost for producing the backlight module and the LCD device can be substantially reduced.

### BACKGROUND OF INVENTION

1. Field of the Invention

The invention relates to an optical film, and more particularly to the optical film that is adhered to a light inlet of a light guiding plate for matching plural side-light sources to form a backlight module applicable to an LCD device. Also, the invention is related to the backlight module and the LCD device that are equipped with the aforesaid optical film.

2. Description of the Prior Art

In the art of the LCD device, the backlight module is used to be a 2-dimension surface light source. In the effort of replacing the cold cathode fluorescent lamp (CCFL) by the LED, well known as a point light source to be the light source for the LCD device, a proper light-guiding mechanism such as the light guide plate used in a side-lighting backlight module is definitely needed for transforming the LED point light source into a homogeneous surface light source applicable to the LED device.

Conventionally, a typical backlight module mainly includes a light source, a light guide plate, a lens set, a light-diffusing plate, a light-reflective plate and so on. The light source for the backlight module can be a CCFL type or an LED type. According to the different locations of the light source, two types of the backlight modules can be concluded; the side-lighting type and the bottom-lighting type. The side-lighting backlight module has a light source located laterally to the module. The light of the side-light source is guided to project homogeneously at a correct upright direction by a deflective light guide plate.

In the art, the light guide plate is the light-guiding media for the backlight module of the LCD device. Particularly, to the side-lighting backlight module, the light guide plate is able to deflect the light in a homogeneous manner to leave the LCD device at a frontward direction. The application of the light guide plate is to reflect and guide the lateral inlet light to a frontward direction of the light guide plate by utilizing a specific structure located at a lateral side of the light guide plate. In addition, besides the light to directly leave at the frontward direction, part of the light in the light guide plate would hit the reflective plate bottom to the light guide plate and be then deflected back to the light guide plate.

Referring to FIG. 1 and FIG. 2, the conventional backlight module 9 includes a light guide plate 91 and a plurality of LED side-light sources 92 located to one lateral side of the light guide plate 91. While the light beam generated by individual light source 92 hits the light guide plate 91, an incident light 921 and a refractive light 922 can be read. As shown, a dark area 923 (free of refractive light 922) would be formed inside the light guide plate 91 between every two neighboring LED side-light sources 92. From a top-down viewing angle of the light guide plate 91, each of the dark areas 923 would be significant as a hot spot (known as the firefly phenomenon in LCD). In order not to have the dark areas 923 damage the image quality of the LCD, the visual window of the LCD is usually defined in a limited manner to waive all the dark areas 923. In general, a dark frame with a substantial width is introduced to shield all these dark areas 923. Thereupon, the effective window 924 of the LCD device would be less in area than the frontward surface of the light guide plate 91. Obviously, such a result from the dark areas 923 is far from being acceptable.

Referring to FIG. 2 and the following Table 1 for a light guide plate 91 with a refractive index n=1.55, the configuration relation in dark area for various incident angles of the incident light 921 of the LED side-light source 92 versus the refractive angles of the refractive light 922 can be found.

TABLE 1
Configuration relation in dark area of a light
guide plate with the refractive index n = 1.55

| | | | | Incident | Refractive | |
|---|---|---|---|---|---|---|
| A | B | | t | angle | angle | C |
| (mm) | (mm) | B/A | (mm) | (θ°) | (θ°) | (mm) |
| 9.5 | 6.5 | 0.68 | 0.5 | 40 | 25 | 6.9 |
| | | | | 50 | 30 | 5.7 |
| | | | | 60 | 34 | 5.0 |
| | | | | 70 | 37 | 4.6 |

In the table, A is the nominal distance between neighboring LED side-light sources, B is the spacing between neighboring LED side-light sources, t is the spacing between the LED side-light source and the lateral surface (incident surface) of the light guide plate 91, and C is the largest height of the triangle dark area 923.

Actually, the C value relates to the area of the dark area 923, which is also related to the degree of the hot spot. A geometrical relationship among B, t, C, the incident angle and the refractive angle can be obtained.

B/2=t*sin(Incident angle)+C*sin(Refractive angle)

Also, following two conclusions can be obtained from Table 1.

(1) By comparing results of Table 1 to actual C values of a current specimen of the backlight module with the LED side-light sources in the marketplace, the computational value of C=5 mm at the 60 ° incident light in Table 1 meets the actual C value of the specimen. Namely, to the specimen, the computational results are close to the truth at the simulation of the 60° incident light; and

(2) The B/A is related to the illuminant regime of the LED side-light source 92 and the packaging, such as 50/30, 30/20 and so on.

### SUMMARY OF THE INVENTION

Accordingly, it is the primary object of the present invention to provide an optical film, a backlight module having the same optical film, and an LCD device also having the same optical film, in which the optical film is adhered to a light-incident surface of a light guide plate for reducing dark areas caused by plural LED side-light sources, so as to enlarge the effective visual window of the LCD device.

It is a secondary object of the present invention to provide an optical film, a backlight module having the same optical film, and an LCD device also having the same optical film, in which the optical film includes a plurality of micro surface structures with appropriate configurations to enlarge the diffusing angle of the incident light to the light guide plate from the individual side-light source, so as to reduce the required number of the LED light sources and thus to reduce the manufacture cost.

In the present invention, the optical film is adhered to a light-incident surface of a light guide plate and to match the arrangement of the plural side-light sources. The optical film includes an incident surface and an opposing out-warding surface. The incident surface further includes a micro structure for allowing the light beams of the side-light sources to enter the optical film. The out-warding surface is adhered to the light-incident surface of the light guide plate for allowing the deflected light beams inside the optical film to leave therefrom and to enter the light guide plate.

In the present invention, following relationship between the optical film and the backlight module formed with the plural side-light sources is satisfied:

B/2/C″[1−tan(θᵢ)]<tan(θ_{t(θ}_{ᵢ}₎)<n/\sqrt{(nt²−n²)};

in which B is the spacing between two neighboring side-light sources, C′ is the largest height of the triangle dark area located inside the light guide plate and formed by the deflected lights of the neighboring side-light sources, θᵢ is the incident angle of the light beam of the side-light source with respect to the incident surface of the optical film, θ_{t(θ}_{ᵢ}₎ is the angle of the deflected light beam inside the light guide plate, n is the refractive index of the light guide plate, and nt is the refractive index of the optical film.

Preferably, the width-depth ratio (P/H) of the micro structure on the incident surface of the optical film satisfies the following relationship:

2<(P/H)<2*{{square root over ([(nt/sin θ_{t(θ}_{ᵢ}₎)²−1)}]−1/sin θ_{t(θ}_{ᵢ}₎};

in which P is the width of the micro structure and H is the depth of the micro structure.

Preferably, the optical film further satisfies the relationships of 10°<θ_{t(θ}_{ᵢ}₎ and 2<P/H.

All these objects are achieved by the optical film, the backlight module having the same optical film, and the LCD device also having the same optical film described below.

### BRIEF DESCRIPTION OF THE DRAWINGS

The present invention will now be specified with reference to its preferred embodiment illustrated in the drawings, in which:

FIG. 1 is a schematic view of a typical backlight module for a conventional LCD device;

FIG. 2 shows light paths of the typical LED side-light sources of FIG. 1;

FIG. 3 shows light paths of the LED side-light sources for a preferred backlight module having a preferred optical film in accordance with the present invention;

FIG. 4A shows conventional light paths of straight light beams inside the light guide plate from an LED side-light;

FIG. 4B shows conventional light paths of oblique light beams inside the light guide plate from an LED side-light source;

FIG. 5 shows light paths of oblique light beams inside the light guide plate from an LED side-light source in accordance with the present invention;

FIG. 6 shows relationships between the incident angle and the correspondent refractive angle for each of the first embodiment through the sixth embodiment of the optical film in accordance with the present invention;

FIG. 7 shows refractions of the light beams from the LED side-light sources to the light guide plate having an optical film in accordance with the present invention;

FIG. 8 shows relationships between B and θₜ₍₆₀₎ for various C′ of the optical film at a 60-degree incident angle of the light beam from the LED side-light sources in accordance with the present invention;

FIG. 9 shows refractions of light beams from the LED side-light sources through the optical film having a preferred micro structure in accordance with the present invention;

FIG. 10 shows light paths for the optical film having a large P/H value in accordance with the present invention;

FIG. 11 shows relationships between P/H and θₜ₍₀₎ for various nt's of the optical film at a 0-degree incident angle of the light beam from the LED side-light sources in accordance with the present invention;

FIG. 12A to FIG. 12C show embodiments of the micro structure for the optical film in accordance with the present invention;

FIG. 13 show optical performance for various light guide plates with/without the optical films in accordance with the present invention; and

FIG. 14A to FIG. 14D show various embodiments of the backlight module having the optical film in accordance with the present invention.

### DESCRIPTION OF THE PREFERRED EMBODIMENT

The invention disclosed herein is directed to an optical film, a backlight module having the same optical film, and an LCD device also having the same optical film. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

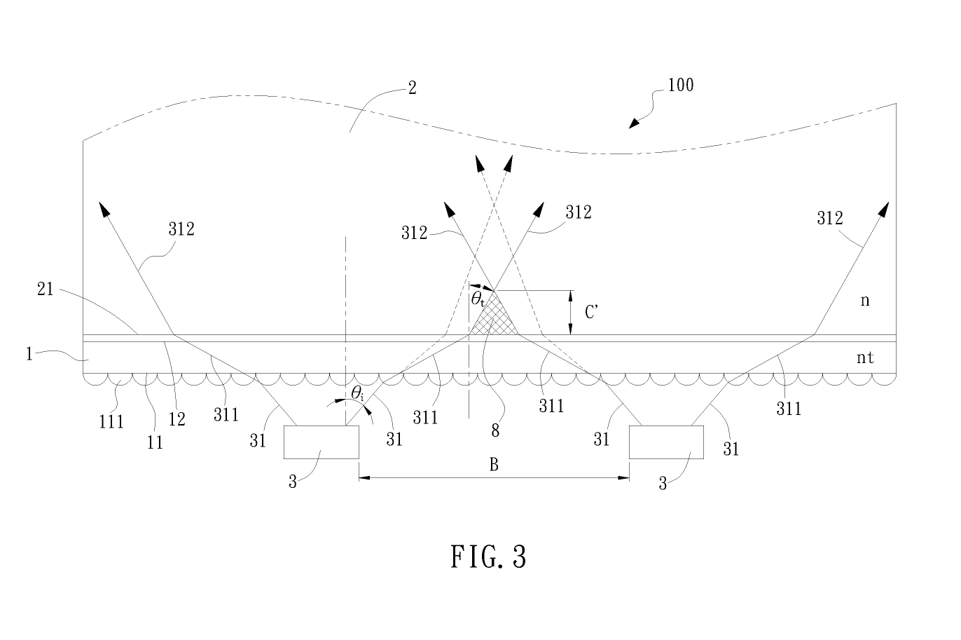

Referring now to FIG. 3, light paths of the LED side-light sources for a preferred backlight module having a preferred optical film in accordance with the present invention are shown. The optical film 1 of the present invention having a micro structure to purposely deflect the light paths is adhered to a light-incident surface 21 of a light guide plate 2. The light guide plate 2 having the optical film 1 can integrate a plurality of side-light sources 3 to form a backlight module 100 applicable to an LCD device. The light guide plate 2 has the light-incident surface 21 and a light-out-warding surface as the frontward surface perpendicular to the light-incident surface 21. The plural side-light sources 3 are located aside by a predetermined spacing to the light-incident surface 21. On the optical film 1, an incident surface 11 and an out-warding surface 12 opposing to the incident surface 11, in which the incident surface 11 further includes a micro structure 111 to deflect light beams 31 therethrough from the side-light sources 3. The out-warding surface 12 of the optical film 1 is to adhere to the light-incident surface 21 of the light guide plate 2 in a flush manner, so as to refract the light beams 31 at the interface of the out-warding surface 12 and the light-incident surface 21.

In one embodiment of the present invention, the plural side-light sources 3 can include a plurality of LEDs at an appropriate arrangement corresponding to the light-incident surface 21 of the light guide plate 2. The light beams 31 of the LED side-light sources 3 are sent through the optical film 1 before entering the light guide plate 2. Defined on the light-incident surface 21 of the light guide plate 2, the light beams 31 can be defined as the incident lights 311 and the refractive lights 312.

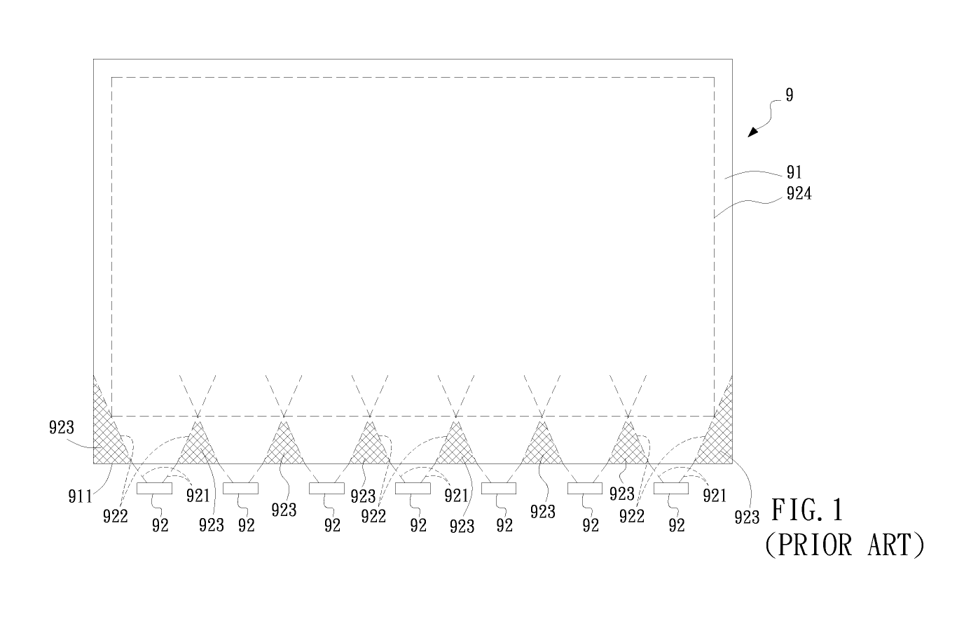

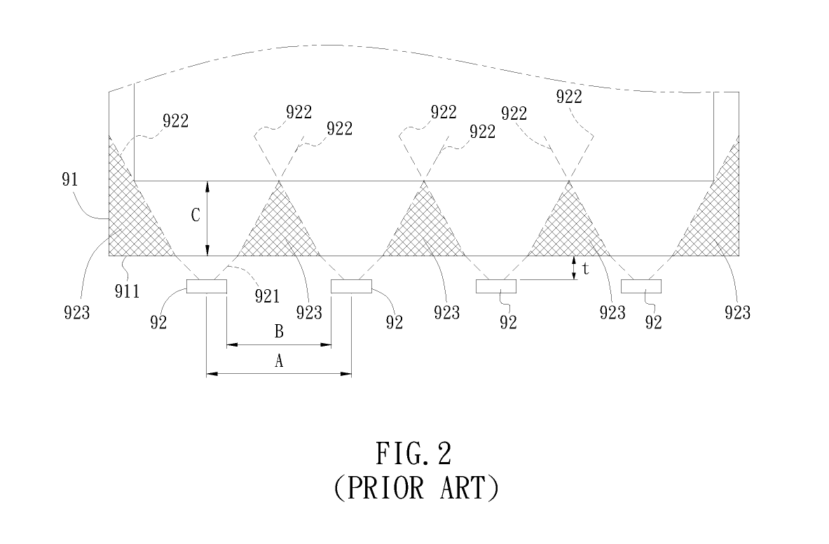

As shown, when the light beams 31 from neighboring LED side-light sources 3 are mixed after entering the light guide plate 2 having the optical film 1, the dark area 8 unshielded by the light beams 31 is shown to be smaller in area than that 923 shown in FIG. 1 for the conventional design without the optical film 1. Thereby, the effective visual window of LCD device having the light guide plate 2 with the optical film 1 in accordance with the present invention can be larger than that of the conventional design. The micro structure 111 on the incident surface 11 of the optical film 1 as shown in FIG. 3 can be embodied as a surface structure with a cross section of a continuous semi-cylindrical shape, a cross section of a wavy shape, diffusing particles, or irregular configurations. Preferably, the refractive index for the optical film 1 of the present invention is ranged between 1.45 and 1.65.

After computation upon the related arrangements (for example, refractive index of the light guide plate n=1.55 and refractive index of the optical film nt=1.62), the optical film 1 of the present invention may need to satisfy the following mathematical relationship:

B/2/C′[1−tan(θᵢ)]<tan(θ_{t(θ}_{ᵢ}₎)<n/\sqrt{(nt²−n²)}

in which B is the spacing between two neighboring side-light sources, C′ is the largest height of the triangle dark area located inside the light guide plate and formed by the deflected light beams of the neighboring side-light sources, θᵢ is the incident angle of the light beams of the side-light source with respect to the incident surface of the optical film, θ_{t(θ}_{ᵢ}₎ is the angle of the deflected light beams inside the light guide plate (i.e. the maximum refractive angle of the refractive light), n is the refractive index of the light guide plate, and nt is the refractive index of the optical film.

Referring to FIG. 3 and Table 1, in a preferred embodiment of the optical film 1 (with nt=1.62) in accordance with the present invention with the same n=1.55 for the light guide plate 2, while the incident light beams 312 of the LED side-light source 3 is at 60 degree (θᵢ=60°), the refractive light beams 312 in the light guide plate 2 of the present invention (in solid lines in FIG. 3) can have a refractive angle θₜ₍₆₀₎>40°, by compared to the θ=34° for refractive light beams 922 the light guide plate 2 without the optical film 1.

Hence, by compared the refractive light beams 922 of the art, the refractive light beams 312 in the light guide plate 2 having the optical film 1 can have a larger refractive angle, and thereby the induced dark area C′ can be reduced. Upon such an arrangement, the hot spots (firefly phenomenon) can thus be better resolved. In particular, if the light refractive angle θ_{t(θ}_{ᵢ}₎ meets the following relationship at θᵢ=60°, an optimal dark area 8 for the backlight module with the optical film can be obtained.

B/2/C′[1−tan(θᵢ)]<tan(θ_{t(θ}_{ᵢ}₎)<n/\sqrt{(nt²−n²)}

Also, following relationship of the width-to-depth ratio (P/H) of the optical film 1 at θᵢ=0° needs to be satisfied.

2<(P/H)<2*{{square root over ((nt/sin θ_{t(θ}_{ᵢ}₎)²−1])}−1/sin θ_{t(θ}_{ᵢ}₎}

Following descriptions would detail the aforesaid two mathematical relationships.

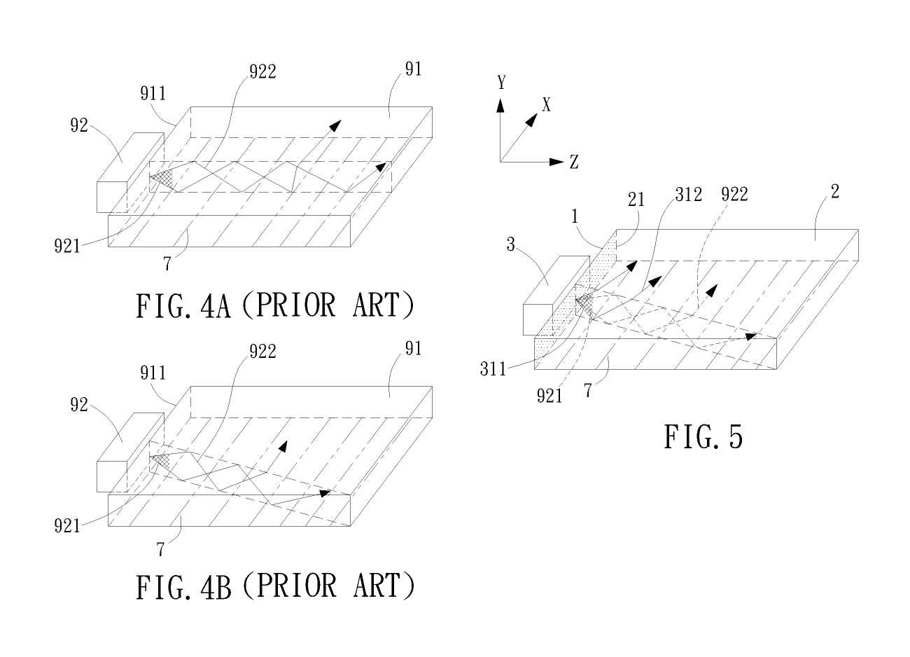

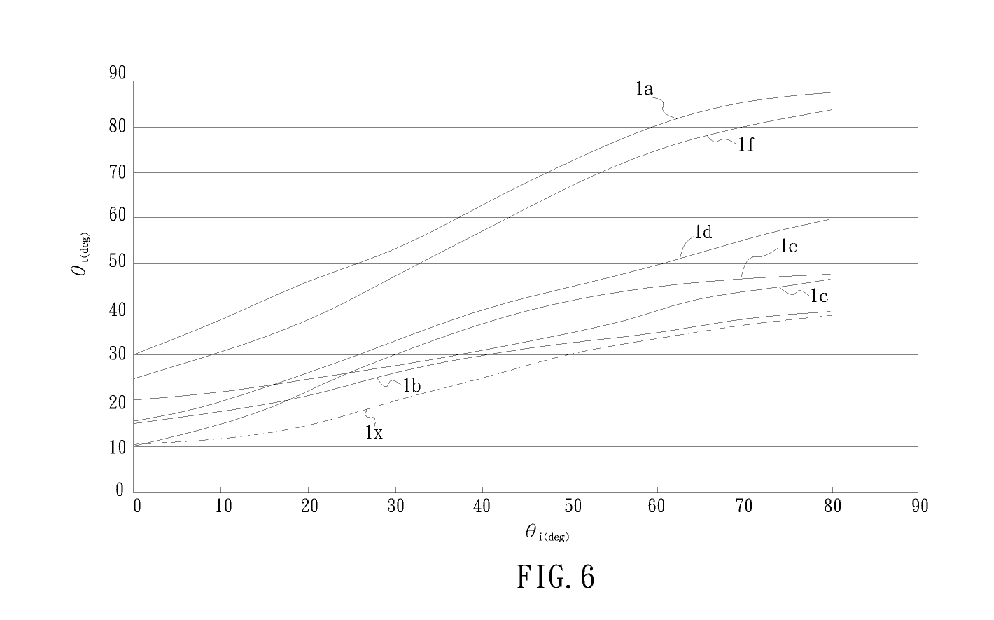

Referring now to FIGS. 4A, 4B and 5, light paths of straight light beams inside a conventional light guide plate without the optical film from an LED side-light, light paths of oblique light beams inside the light guide plate without the optical film from an LED side-light source, and light paths of oblique light beams inside the light guide plate with the optical film from an LED side-light are shown, respectively.

As shown, an X-Y-Z coordinate system is introduced to better elucidate the explanation upon the figures. Light beams from the LED side-light source 92 or 3 enter the light guide plate 91 or 2 through the light-incident surface 911 or 21, and are sent through the light guide plate 91 or 2 according to the optical theory of total internal reflection (TIR). When the light beams hit a light-capturing structure 7 (for example, a printed node, a micro structure, a V-shape groove, a lens or a reflection surface) inside the light guide plate 91 or 2, the light beams can be redirected to form a corresponding surface light source projecting upward. For a Lambertian light source distribution is applied to the LED side-light sources 92 or 3, a major diffusive regime (oblique-lined area) within ±60° about the normal line (Z axis) for the refractive lights 922 or 312 inside the light guide plate 91 or 2 can be obtained.

In the aforesaid coordinate system, the X axis follows the direction parallel to the light-incident surface 911 or 21, the Y axis follows the front upright direction of the light guide plate 91 or 2, and the Z axis follows the direction normal to the light-incident surface 911 or 21. As shown in FIG. 5, the light-incident surface 21 of the light guide plate 2 is adhered with the optical film 1 of the present invention. The optical film 1 breaks the TIR theory at the light beams propagating obliquely, the optical capture at the middle area of the neighboring LED side-light sources 3 is increased, the dark area 8 is thus made smaller, and also the C value is substantially lowered.

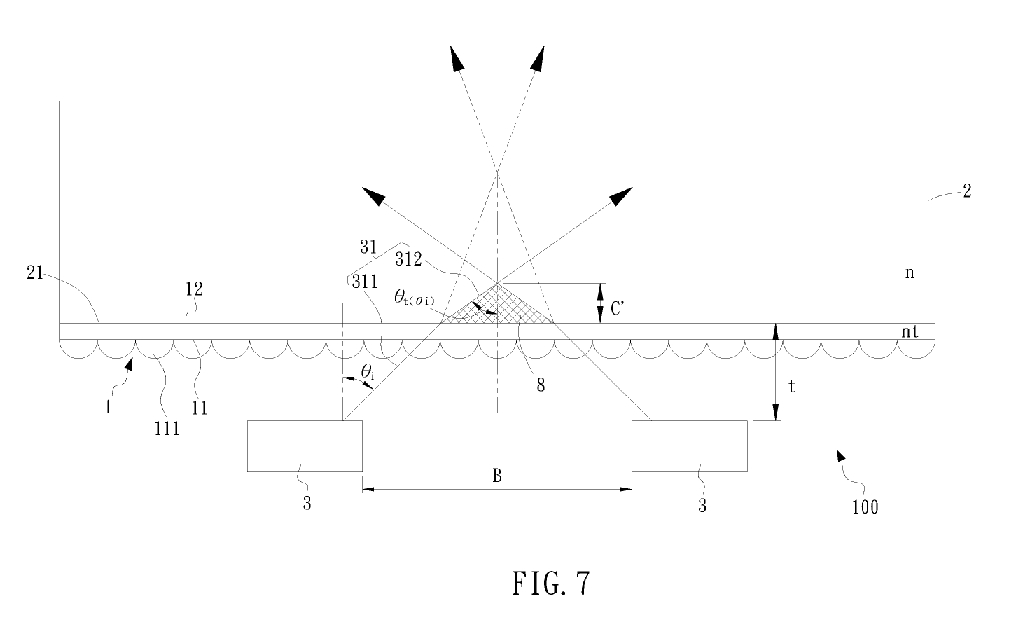

Refer now to FIG. 6 and the following Table 2, in which FIG. 6 shows relationships between the incident angles (0°, 20°, 30°, 40°, 50°, 60°, 70° and 80°) and the correspondent refractive angles θ_{t(θ}_{ᵢ}₎ for each of the first embodiment 1a through the sixth embodiment 1f of the optical film in accordance with the present invention and Table 2 shows correspondent data of refractive angles between pairs of embodiments (1a-1f) and incident angles (0° and 60°).

TABLE 2
Test data for the optical film of the present invention (unit: degree)

| | w/o | | | | | | |
|---|---|---|---|---|---|---|---|
| Refractive | optical | | | | | | |
| angle | film | Emb't | Emb't | Emb't | Emb't | Emb't | Emb't |
| θₜ | 1x | 1a | 1b | 1c | 1d | 1e | 1f |
| θₜ₍₀₎ | 10 | 30 | 15 | 20 | 15 | 10 | 25 |
| θₜ₍₆₀₎ | 34 | 80 | 35 | 40 | 50 | 45 | 75 |

Taking the LED side-light sources 2 with incident angles less than 60 degree for example, while θᵢ=60° and C′=5 mm, the θₜ₍₆₀₎ for the optical film 2 in embodiment 1a is 80 degree; and while θᵢ=0° and C′=5 mm, the θₜ₍₀₎ is 30 degree. Further, by comparing 1a and 1x in Table 2, the difference in θₜ₍₀₎ is 20 degree for the case of θᵢ=0, and difference in θₜ₍₆₀₎ is extended to 46 degree for the case of θᵢ=60°.

Therefore, no matter whether the light-incident angle θᵢ of the light beams of the LED side-lighting sources 3 is 0 degree or 60 degree, the refractive angle θₜ for the light guide plate 2 with the optical film 1 (embodiment 1a) is strictly larger than that for the light guide plate without the optical film (embodiment 1x). Namely, the dark area 8 in the present invention can be made smaller by compared to the skill in the art.

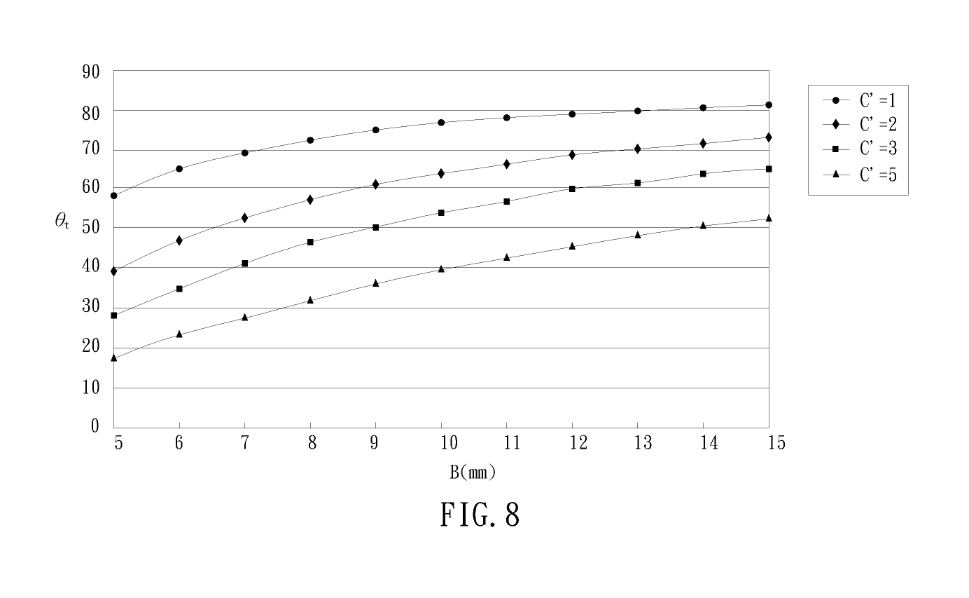

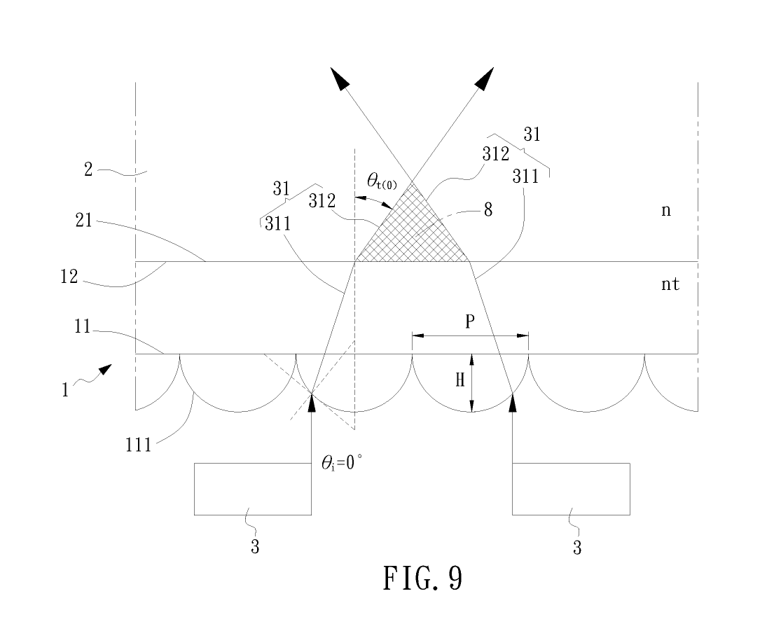

Refer now to FIG. 7 and FIG. 8, in which FIG. 7 shows refractions of the light beams from the LED side-light sources to the light guide plate having an optical film in accordance with the present invention and FIG. 8 shows relationships between B and θₜ₍₆₀₎ for various C′ of the optical film at a 60-degree incident angle of the light beams from the LED side-light sources in accordance with the present invention.

Based on an oblique geometric optical analysis, a relationship among B, C′, θhd i and θ_{t(θ}_{ᵢ}₎ can be obtained as follows.

B/2=t×tan(θᵢ)+C′×tan(θ_{t(θ}_{ᵢ}₎)

Accordingly, from the foregoing relationship, the tan(θ_{t(θ}_{ᵢ}₎) must satisfy the following criteria so as to obtain a small C′ value and a smaller dark area. These criteria are:

B/2/C′−t/C′×tan(θᵢ)<tan(θ_{t(θ}_{ᵢ}₎)<n/\sqrt{(nt²−n²)}, (θᵢ=60); and the related derivative from above relationship

B/2/C′[1−tan(θᵢ)]<tan(θ_{t(θ}_{ᵢ}₎)<n/\sqrt{(nt²−n²)}, (θᵢ=60).

In the present invention, the tan(θ_{t(θ}_{ᵢ}₎) value must smaller than the, n/\sqrt{(nt²−n²)} value, or total internal reflection may occur between the optical film 1 and the light guide plate 2, by which the light beams may be rejected by the light guide plate 2. With a given B value, the tan(θ_{t(θ}_{ᵢ}₎) value can be adjusted to meet the aforesaid criteria by altering the P/H value of the micro structure 111 of the optical film 1 or the difference of refractive index between the optical film 1 and the light guide plate 2.

By analyzing the aforesaid relationships, it can be concluded that the addition of the optical film 1 can change the size of the dark area 8. Namely, the smallest refractive angle θₜ for various B's can be obtained. Referring to FIG. 8, the changes in dark area 8 for 1 mm, 2 mm, 3 mm and 5 mm C′ values are shown.

For example, to an LCD device with a regular specs for the LED side-light sources 3 (usually having incident angles less than 60 degree), following two observation can be obtained from the 3 mm C′ value for the dark area 8.

(1) When B=9 mm, θₜ₍₆₀₎=50°, which is 16 degree larger than that (34 degree) of embodiment 1x in Table 2. In a related computation, the dark area for the embodiment 1x has about a 5.4 mm C value. That is to say that the C′ value for the dark area 8 of the present invention will be smaller than 5.4 mm.

(2) When B=12 mm, θₜ₍₆₀₎=60°, which is 26 degree larger than that (34 degree) of embodiment 1x in Table 2.

In summary, it is obvious that the optical film 1 of the present invention can effectively reduce the area in the dark area 8 which is formed in the light guide plate 1 by mixing light beams from two neighboring LED side-light sources 3. Further, by adjusting the B value for the light guide plate having the optical film 1 of the present invention, the C′ value as well as the area in the dark area 8 can be purposely designed. However, to avoid possible TIR between the optical film 1 and the light guide plate 2, following relationship must be satisfied.

θ_{t(θ}ᵢ₎=tan⁻¹[n/\sqrt{(nₜ²−n²)}]

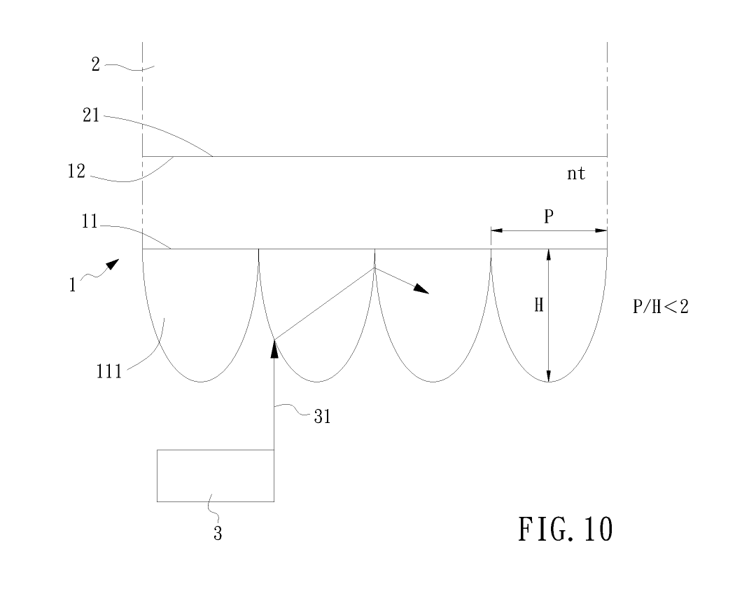

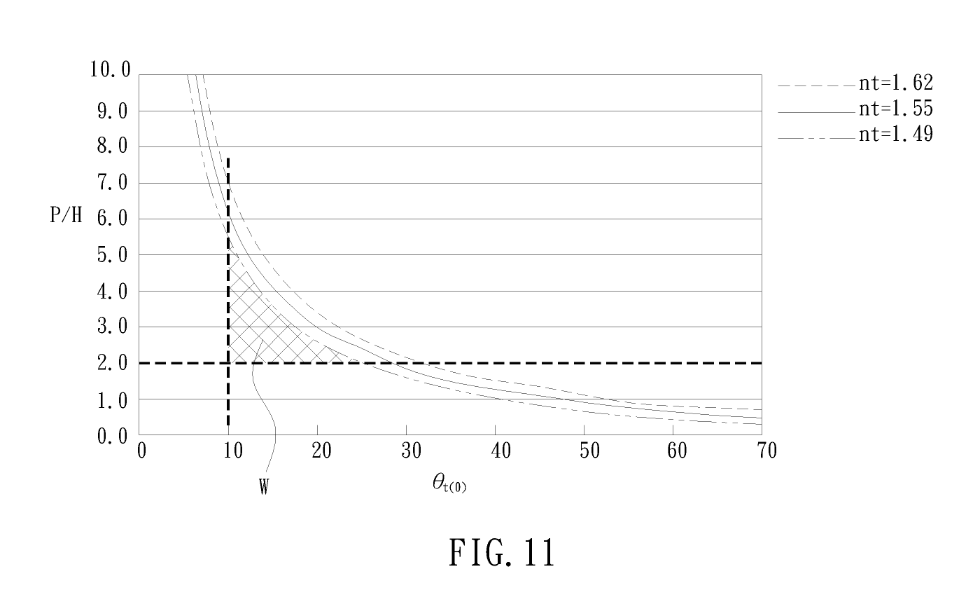

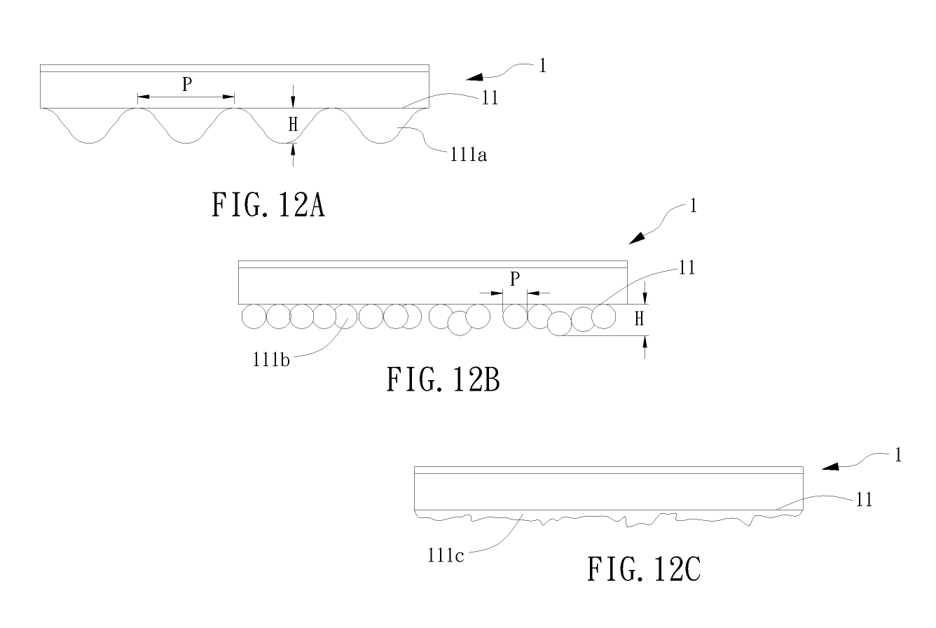

Refer now to FIG. 9, FIG. 10 and FIG. 11, in which FIG. 9 shows refractions of light beams from the LED side-light sources through the optical film having a preferred micro structure in accordance with the present invention; FIG. 10 shows light paths for the optical film having a large P/H value in accordance with the present invention; and, FIG. 11 shows relationships between P/H and νₜ₍₀₎ for various nt's of the optical film at a 0-degree incident angle of the light beam from the LED side-light sources in accordance with the present invention.

As shown in FIG. 9, it is noted that the refractive angle θₜ₍₀₎ inside the light guide plate 2, deflected from the light beams 31 of the 0-degree incident angle θᵢ of the LED side-light sources 3, is also one of the factors to affect the C′ value of the dark area 8. According to the geometric optical analysis, the refractive angle θₜ₍₀₎ is related to the depth H of the micro structure 111 on the incident surface 11 of the optical film 1. To the optical film 1 in this invention which is typically embodied to have a micro structure 111 with continuous cross section of semi-cylinders, the P/H ratio for the micro structure 111 needs to satisfy the following relationship:

2<(P/H)<2*{{square root over ([(nt/sin θ_{t(θ}_{ᵢ}₎)²−1])}−1/sin θ_{t(θ}_{ᵢ}₎}, (θᵢ=0);

in which P is the width of the micro structure 111 and H is the depth of the microstructure 111. Preferably, the P is to be ranged between 20 μm and 200 μm.

As shown in FIG. 10, the micro structure 111 of the optical film 1 has a P/H ratio less than 2, from which it is implied that the structural depth H of the micro structure 111 is too large to project the light beams 31 from the LED side-light sources 3 into the light guide plate 2. Hence, to avoid such a deviation in light path, the micro structure 111 of the optical film 1 needs to satisfy the following criteria:

(1) P/H>2; and

(2) θₜ₍₀₎>10°.

As shown in FIG. 11, relationships between P/H of the micro structure 111 and the refractive angle θₜ₍₀₎ of the light guide plate 2 for various nt's (1.49, 1.55 and 1.66) of the optical film 1 at a 0-degree incident angle of the light beams 31 from the LED side-light sources 3 in accordance with the present invention are illustrated. It is known from above that P/H must be greater than 2 so as to avoid possible severe deviation in light path (criterion (1)). Also, the aforesaid criterion (2) for θₜ₍₀₎>10° must be met, too. Hence, an optimal area W for the optical film 1 can be located. Namely, upon a fixed P/H ratio for the micro structure 111, as the nt for the optical film 1 increases, so does the refractive angle θₜ₍₀₎ of the refractive light 312 of the light beams 31 entering the light guide plate 2. Also, the area in the dark area 8 as well as the C′ value are made smaller. Thereby, the phenomenon in hot spots can be substantially improved. Alternatively, under a given B, the C′ value can be adjusted by changing the P/H ratio of the micro structure 111 or the difference in refractive index between the optical film 1 and the light guide plate 2.

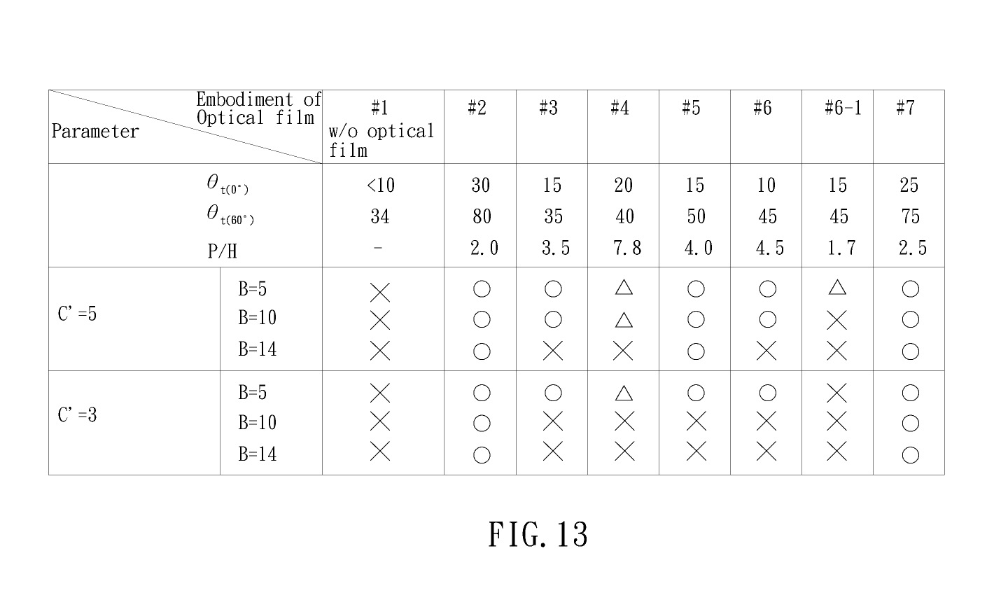

Referring now to FIG. 12A to FIG. 12C, three embodiments of the micro structure 111 on the optical film 1 in accordance with the present invention are schematically shown. In FIG. 12A, the micro structure 111 is embodied as a micro structure having a continuous wavy micro structure 111a. In FIG. 12B, the micro structure 111 is embodied as a micro structure having diffusive particles 111b. In FIG. 12C, the micro structure 111 is embodied as a micro structure having irregular or hairy micro structures 111c. All the above micro structures 111a, 111b and 111c need to meet the two aforesaid criteria.

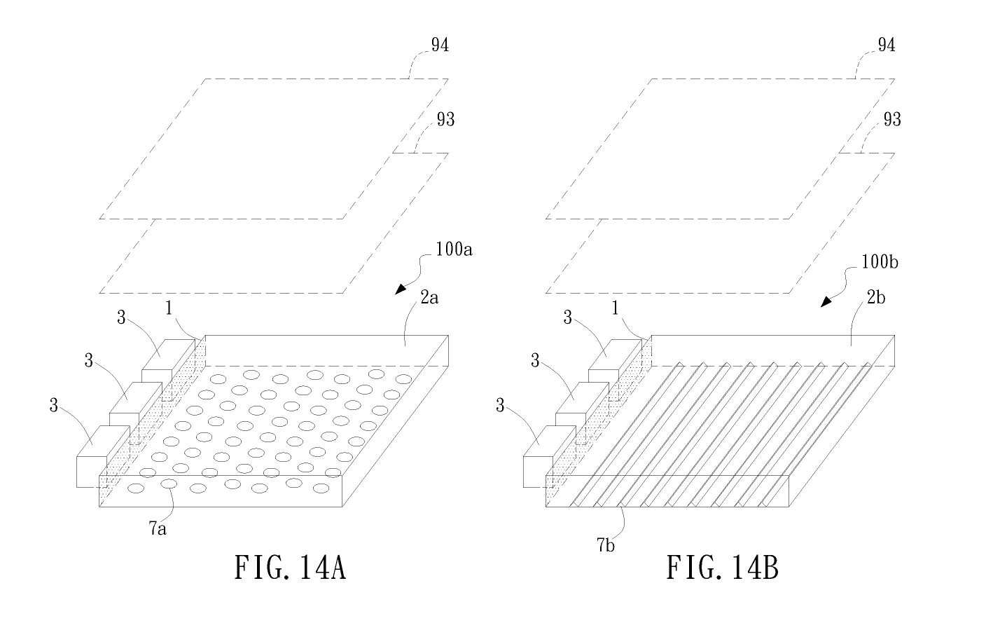

Referring now to FIG. 13, a comparison of optical performance for various light guide plates with/without the optical films in accordance with the present invention is shown. Parameters involved in the comparison to include θₜ₍₀₎, θₜ₍₆₀₎, and P/H with respect to three B's (5 mm, 10 mm and 14 mm) in each of two C's (3 mm and 5 mm).

In FIG. 13, embodiment #1 is the embodiment of the light guide plate 2 without the optical film 1, and embodiments #2˜#7 are embodiments of the light guide plate 2 with the optical film 1 of the present invention, in which embodiments #2˜#7 satisfy the following two relationships:

B/2/C′[1−tan(θᵢ)]<tan(θ_{t(θ}_{ᵢ}₎)<n/\sqrt{(nt²−n²)}; and

2<(P/H)<2*{{square root over ([(nt/sin θ_{t(θ}_{ᵢ}₎)²−1])}−1/sin θ_{t(θ}_{ᵢ}₎}.

Also, the aforesaid two criteria (1) P/H>2 and (2) θₜ₍₀₎>10° should meet. In FIG. 13, the appearance of the hot spot is judged; in which ◯ means a satisfaction, × means a dis-satisfaction, and Δ means a fair result.

From the results in embodiments #6-1 and #6, the P/H ratio is beyond the range of 2<(P/H)<2*Δ{square root over ([(nt/sin θ_{t(θ}_{ᵢ}₎)²−1])}−1/sin θ_{t(θ}_{ᵢ}₎}, i.e. a over-sized dark area 8 occurs. From embodiment #4, for the cases of C′=5 (B=5 and B=10) and C′=3 (B=5) satisfy B/2/C′[1−tan(θ₁)] tan(θ_{t(θ}_{ᵢ}₎) n/\sqrt{(nt²−n²)}, but do not meet 2<(P/H)<2*{{square root over ([(nt/sin θ_{t(θ}_{ᵢ}₎)²−1)}−1/sin θ_{t(θ}_{ᵢ}₎}, thus the hot spot can still be found from the dark area 8 of the light guide plate 2.

Further, from the embodiments #2 and #7 in FIG. 13, all the cases (B=5, B=10 and B=14 for both C′=5 and C′=3) satisfy B/2/C′[1−tan(θᵢ)]<tan(θ_{t(θ}_{ᵢ}₎)<n/\sqrt{(nt²−n²)} and 2<(P/H)<2*{{square root over ([(nt/sin θ_{t(θ}_{ᵢ}₎)²−1])}−1/sin θ_{t(θ}_{ᵢ}₎}. Therefore, the dark area 8 is smaller in size and thus the number of the LED side-light sources 3 cane be reduced.

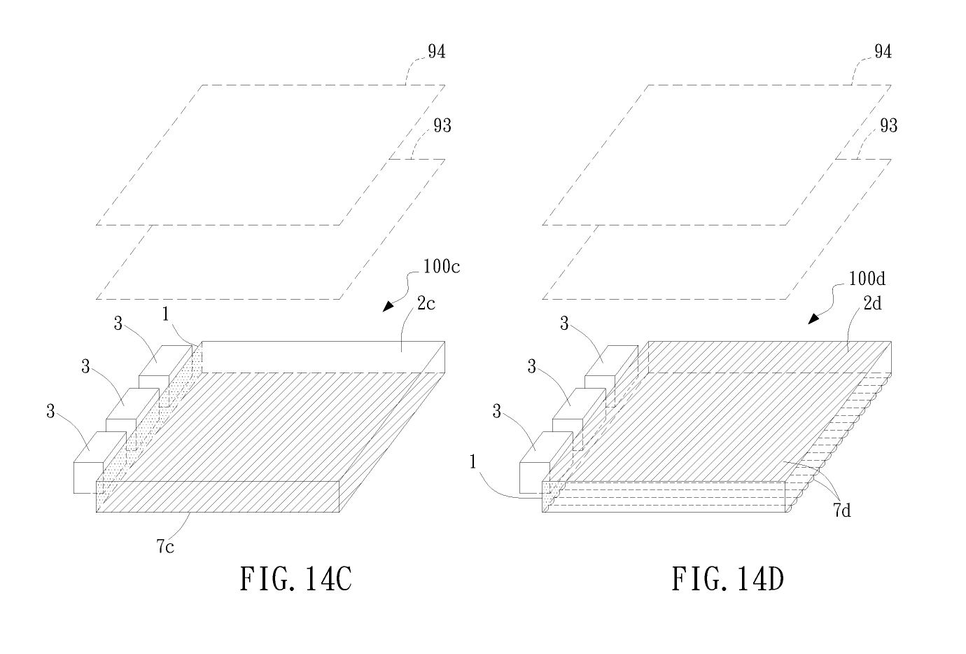

Referring now to FIG. 14A through FIG. 14D, various embodiments of the backlight module having the optical film in accordance with the present invention are shown. Among, following differences can be obvious.

1. In FIG. 14A, the backlight module 100a having the optical film 1 of the present invention includes a light guide plate 2a having a surface structured to a net structure as the optical capturing structure 7a.

2. In FIG. 14B, the backlight module 100b having the optical film 1 of the present invention includes a light guide plate 2b having a surface structured to a V-shape groove structure as the optical capturing structure 7b.

3. In FIG. 14C, the backlight module 100c having the optical film 1 of the present invention includes a light guide plate 2c having a surface structured to an irregular structure (for example, formed by a sand spraying process) as the optical capturing structure 7c.

4. In FIG. 14D, the backlight module 100d having the optical film 1 of the present invention includes a light guide plate 2d having opposing surfaces, one formed as a V-shape groove structure 7d (perpendicular to the light bars) and another formed as a net structure or an irregular structure 2d.

As shown in FIG. 14A to FIG. 14D, after the optical film 1 is adhered to the light-incident surface of the light guide plate 2a, 2b, 2c or 2d and is accompanied by the LED side-light sources 3, the backlight module 100a, 100b, 100c, 0r 100d is formed. Each of the backlight modules 100a, 100b, 100c and 100d can integrate an LCD panel 94 at the respective light-out-warding surface of the corresponding light guide plate 2a, 2b, 2c or 2d to form an LCD device. Further, an optical membrane 93 can be introduced to cover the light-out-going surface of the corresponding light guide plate 2a, 2b, 2c or 2d so as to enhance the light-distributing performance and increase the visual taste.

While the present invention has been particularly shown and described with reference to a preferred embodiment, it will be understood by those skilled in the art that various changes in form and detail may be without departing from the spirit and scope of the present invention.

What is claimed is:

1. An optical film, adhered to a light-incident surface of a light guide plate, to be used by accompanying a plurality of side-light sources, further having an incident surface and an out-warding surface, the incident surface including thereof a surface micro structure for passing light beams from the side-light sources to the optical film through the incident surface, the out-warding surface being adhered to the light-incident surface of the light guide plate in a flush manner, the light beams being deflected by the optical film before entering the light guide plate, the optical film being characterized on that:
a combination of the optical film and the plurality of the side-light sources satisfy the relationship of B/2/C′[1−tan(θᵢ)]<tan(θ_{t(θ}_{ᵢ}₎)<n/\sqrt{(nt²−n²)}, in which B is a spacing between the two neighboring side-light sources, C′ is the largest height of a triangle dark area located inside the light guide plate and formed by the deflected light beams, θᵢ is an incident angle of the light beams of the side-light source with respect to the incident surface of the optical film, θ_{t(θ}_{ᵢ}₎ is an angle of the deflected light beams inside the light guide plate, n is a refractive index of the light guide plate, and nt is a refractive index of the optical film.

2. The optical film according to claim 1, wherein a width-to-depth (P/H) ratio of said micro structure of said incident surface satisfies the relationship of 2<(P/H)<2*{{square root over ((nt/sin θ_{t(θ}_{ᵢ}₎)²−1])}−1/sin θ_{t(θ}_{ᵢ}₎}, in which P is a width of said microstructure and H is a depth of said micro structure.

3. The optical film according to claim 2, further satisfying: θ_{t(θ}_{ᵢ}₎>10°, P/H>2 and 20 μm≦P≦200 μm.

4. The optical film according to claim 1, wherein said micro structure on said incident surface is one of a micro structure having continuous semi-cylinders, a micro structure having continuous wavy structures, a micro structure having diffusive particles, and a micro structure having irregular structures, said optical film having a refractive index ranged between 1.45 and 1.64, said plurality of side-light sources including a plurality of LEDs.

5. A backlight module having an optical film, comprising:
a light guide plate, further having a light-incident surface and a light-out-warding surface perpendicular to the light-incident surface;
a plurality of side-light sources, located aside to the light-incident surface; and
an optical film, further having an incident surface and an out-warding surface, the incident surface including thereof a surface micro structure for passing light beams from the side-light sources to the optical film through the incident surface, the out-warding surface being adhered to the light-incident surface of the light guide plate, the light beams being deflected by the optical film before entering the light guide plate, the optical film being characterized on that:
a combination of the optical film and the plurality of the side-light sources and a width-to-depth ratio of the micro structure satisfy the relationship of B/2/C′[1−tan(θ₁)]<tan(θ_{t(θ}_{ᵢ}₎)<n/\sqrt{(nt²−n²)}, in which B is a spacing between the two neighboring side-light sources, C′ is the largest height of a triangle dark area located inside the light guide plate and formed by the deflected light beams, θᵢ is an incident angle of the light beams of the side-light source with respect to the incident surface of the optical film, θ_{t(θ}_{ᵢ₎} is an angle of the deflected light beams inside the light guide plate, n is a refractive index of the light guide plate, and nt is a refractive index of the optical film.

6. The backlight module according to claim 5, wherein said width-to-depth (P/H) ratio of said micro structure of said incident surface satisfies the relationship of 2<(P/H)<2*{{square root over ([(nt/sin θ_{t(θ}_{ᵢ}₎)²−1])}−1/sin θ_{t(θ}_{ᵢ}₎}, in which P is a width of said microstructure and H is a depth of said micro structure.

7. The backlight module according to claim 6, further satisfying: θ_{t(θ}_{ᵢ}₎>10°, P/H>2 and 20 μm≦P≦200 μm.

8. The backlight module according to claim 5, wherein said micro structure on said incident surface is one of a micro structure having continuous semi-cylinders, a micro structure having continuous wavy structures, a micro structure having diffusive particles, and a micro structure having irregular structures.

9. The backlight module according to claim 5, wherein said optical film has a refractive index ranged between 1.45 and 1.64, said plurality of side-light sources includes a plurality of LEDs.

10. An LCD device having an optical film, comprising:
a light guide plate, further having a light-incident surface and a light-out-warding surface perpendicular to the light-incident surface;
a plurality of side-light sources, located aside to the light-incident surface;
an LCD, mounted to the light-out-warding surface of the light guide plate; and
an optical film, further having an incident surface and an out-warding surface, the incident surface including thereof a surface micro structure for passing light beams from the side-light sources to the optical film through the incident surface, the out-warding surface being adhered to the light-incident surface of the light guide plate, the light beams being deflected by the optical film before entering the light guide plate, the optical film being characterized on that:
a combination of the optical film and the plurality of the side-light sources and a width-to-depth ratio of the micro structure satisfy the relationship of B/2/C′[1−tan(θᵢ)]<tan(θ_{t(θ}_{ᵢ}₎)<n/\sqrt{(nt²−n²)}, in which B is a spacing between the two neighboring side-light sources, C′ is the largest height of a triangle dark area located inside the light guide plate and formed by the deflected light beams, θᵢ is an incident angle of the light beams of the side-light source with respect to the incident surface of the optical film, θ_{t(θ}_{ᵢ}₎ is an angle of the deflected light beams inside the light guide plate, n is a refractive index of the light guide plate, and nt is a refractive index of the optical film.

11. The LCD device according to claim 10, wherein said width-to-depth (P/H) ratio of said micro structure of said incident surface satisfies the relationship of 2<(P/H)<2*{{square root over ((nt/sin θ_{t(θ}_{ᵢ}₎)²−1])}−1/sin θ_{t(θ}_{t(θ}_{ᵢ}₎}, in which P is a width of said microstructure and H is a depth of said micro structure.

12. The LCD device according to claim 11, further satisfying: θ_{t(θ}_{ᵢ}₎>10°, P/H>2 and 20 μm≦P≦200 μm.

13. The LCD device according to claim 10, wherein said micro structure on said incident surface is one of a micro structure having continuous semi-cylinders, a micro structure having continuous wavy structures, a micro structure having diffusive particles, and a micro structure having irregular structures.

14. The LCD device according to claim 10, wherein said optical film has a refractive index ranged between 1.45 and 1.64, said plurality of side-light sources includes a plurality of LEDs.
